(19) United States
(12) Patent Application Publication
(10) Pub. No.: US 2007/0242881 A1
(43) Pub. Date: Oct. 18, 2007

(54) SEGMENTATION OF DIGITAL IMAGES OF AN OBSERVATION AREA IN REAL TIME

(75) Inventors: Olivier GACHIGNARD, Montrouge (FR); Jean-Claude SCHMITT, Savigny S/Orge (FR)

Correspondence Address: LOWE HAUPTMAN HAM & BERNER, LLP, 1700 DIAGONAL ROAD, SUITE 300, ALEXANDRIA, VA, 22314, US

(73) Assignee: FRANCE TELECOM, Paris (FR)

(21) Appl. No.: 11/734,412

(22) Filed: Apr. 12, 2007

(30) Foreign Application Priority Data
Apr. 14, 2006 (FR) 0651357

(51) Int. Cl. G06K 9/34; G06K 9/00

(52) U.S. Cl. 382/173; 382/103

(57) ABSTRACT

For segmenting in real time a first digital image of an observation area captured by an image capture device and transmitted to a data processing device, a second digital image each pixel of which is associated with a magnitude such as a distance relative to a point of the observation area is captured and transmitted by another image capture device to the data processing device. An image merging module establishes a correspondence between pixels of the first image and pixels of the second image and selects the pixels of the first image corresponding to the associated pixels of the second image as a function of magnitudes associated with the pixels of the second image. Only the selected pixels of the first image are displayed to form a segmented image.

### BACKGROUND OF THE INVENTION

1—Related Applications

The present application is based on, and claims priority from, French Application Number 0651357, filed Apr. 14, 2006, the disclosure of which is hereby incorporated by reference herein in its entirety.

2—Field of the Invention

The present invention relates to segmentation of digital images of an observation area captured by a visible image capture device, such as a video camera, in real time. It relates more particularly to displaying an object or a person extracted from the image of the observation area.

3—Description of the Prior Art

In the field of videoconference or videotelephony, users generally do not want to show images of their intimate environment using an image capture device such as a camera or a webcam. This reticence of users may constitute a psychological impediment to the use of videotelephony in the home.

Moreover, in the field of radio communications, a user having a mobile terminal equipped with a miniature camera transmits to another user having a mobile terminal a videophone message including an image consisting essentially of a useful portion corresponding to the silhouette or to the face of the user, for example. The information rate necessary for the transmission of the message across the network could then be reduced by transmitting only the useful image portion and eliminating the remainder of the image, corresponding for example to the decor in which the user is located.

In the prior art there exist systems that use projection of infrared electromagnetic waves in a particular scene and analyze the projected waves in order to make a distinction between persons and objects. However, these systems require a complex and costly installation, ill adapted to real time applications, such as videoconference.

### OBJECT OF THE INVENTION

To remedy the problems referred to hereinabove, a method according to the invention for segmenting in real time a first digital image of an observation area captured by an image capture system that also captures a second digital image of the observation area, is characterized in that includes the following steps executed in the image capture system:

establishing a correspondence between pixels of the first image and pixels of the second image and selecting pixels of the first image corresponding to pixels of the second image as a function of magnitudes associated with the latter pixels, and

displaying only the selected pixels of the first image to form a segmented image.

The invention advantageously provides a segmented image displaying only an image portion that a user of the data processing device wishes to transmit to a party with whom he is communicating, for example during a videoconference. The displayed image portion generally represents the user and the decor in which the user is located is eliminated in the segmented image.

The image portion requires a lower bit rate for it to be transmitted to said party, which frees bandwidth for transmitting in real time a video sequence including a succession of segmented images.

Moreover, segmentation in accordance with the invention does not require a particular decor in the observation area, such as a monochrome (conventionally blue) background, and can therefore be executed without constraints anywhere.

According to another feature of the invention, the method may further include updating of the magnitudes associated with the pixels of the second image relating to observation area points whose position has changed.

Updating these magnitudes takes account of the movement of the objects in the observation area in order for the segmented image always to correspond to the image portion that the user wishes to transmit.

According to another feature of the invention, the magnitude associated with a pixel of the second image is a distance between a point of the observation area and the image capture system. According to other embodiments of the invention, the magnitude associated with a pixel of the second image is a luminance level depending on the material of the objects situated in the observation area or on the heat given off by those objects.

According to another feature of the invention, the method may include determining a distance threshold in the second image relative to the system, the pixels of the second image corresponding to the selected pixels of the first image being associated with distances less than the distance threshold.

If the segmented image represents the user, the method includes updating of the distances associated with the pixels of the second digital image relating to observation area points whose position has changed, and the distance threshold is at least equal to the greatest updated distance in order to track the user regardless of his position.

According to another feature of the invention, the method may further include establishing a correspondence between pixels of the first image and pixels of a third digital image representing luminance levels of the observation area and deselecting the pixels of the first image that are associated with a luminance level less than a predetermined threshold.

Image segmentation in accordance with the invention distinguishes the user from objects in the observation area liable to be near the user, with the aid of levels of luminance of the observation area. The segmented image can then represent only the user even though objects are situated between the observer and the first device.

According to another feature of the invention, the method may further include constructing a volume mesh as a function of the segmented image by associating distances and coordinates of a frame of reference of the segmented image respectively with the pixels of the segmented image in order to create a tridimensional virtual object.

The tridimensional virtual object created in this way can be imported into tridimensional virtual decors. For example, the virtual object represents the user embedded in scenes from a video game.

According to another feature of the invention, the method may further include modifying the segmented image by inserting a background image that can be an animation, into the background of the segmented image. The segmented image modified in this way can represent the user in a decor selected by the user.

The invention relates also to an image capture system for real time segmentation of a first digital image of an observation area, including a first device for capturing the first digital image and a second device for capturing a second digital image of the observation area. The image capture system includes:
means for establishing a correspondence between pixels of the first image and the pixels of the second image and selecting pixels of the first image corresponding to pixels of the second image as a function of magnitudes associated with the latter pixels and
means for displaying only the selected pixels of the first image to form a segmented image.

The image capture system may be included in a mobile terminal.

The invention also relates to a segmentation device for real time segmentation of a first digital image of an observation area captured by a first capture device and transmitted to the segmentation device, a second digital image of the observation area being captured and transmitted by a second capture device to the segmentation device. The device includes:
means for establishing a correspondence between pixels of the first image and the pixels of the second image and selecting pixels of the first image corresponding to pixels of the second image as a function of magnitudes associated with the latter pixels and
means for displaying only the selected pixels of the first image to form a segmented image.

The invention relates further to a computer program adapted to be executed in a segmentation device for real time segmentation of a first digital image of an observation area captured by a first capture device and transmitted to the segmentation device, a second digital image of the observation area being captured and transmitted by a second capture device to the segmentation device, said program including instructions which, when the program is executed in said segmentation device, execute the steps of the method of the invention.

### BRIEF DESCRIPTION OF THE DRAWINGS

Other features and advantages of the present invention will be apparent more clearly from the reading of the following description of several preferred embodiments of the invention, given by way of nonlimiting examples and with reference to the corresponding accompanying drawings in which:

FIG. 1 is a schematic block-diagram of an image segmentation device in an image capture system according to the invention; and

FIG. 2 is an algorithm of an image segmentation method according to the invention.

### DESCRIPTION OF THE PREFERRED EMBODIMENTS

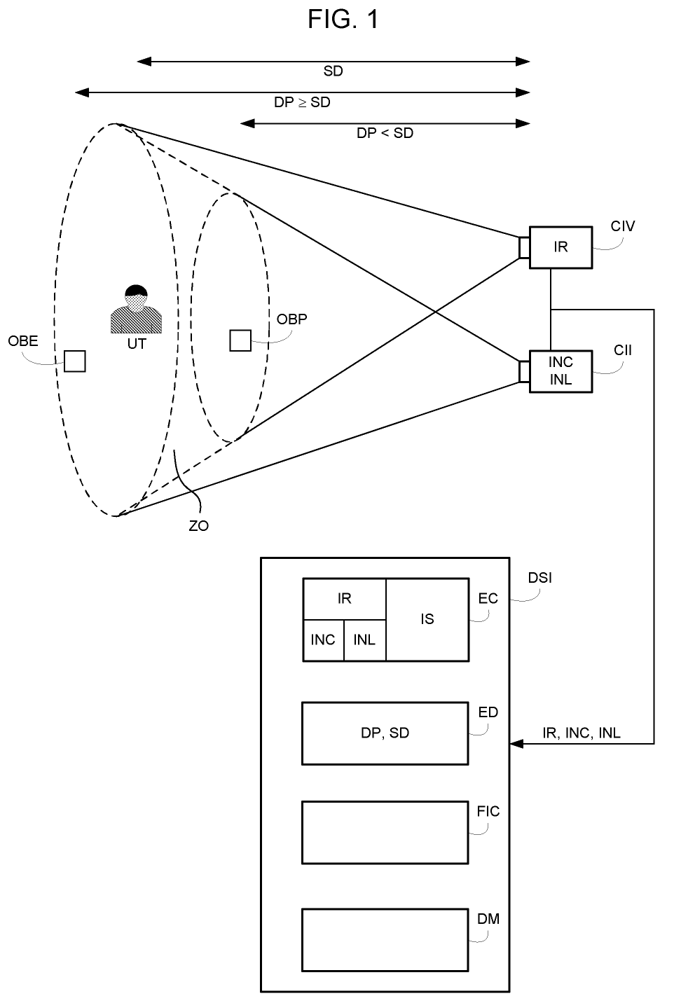

Referring to FIG. 1, an image capture system includes a visible image capture device CIV, an invisible image capture device CII, and an image segmentation data processing device DSI.

The visible image capture device CIV and the invisible image capture device CII are disposed facing a user UT situated in an observation area ZO. The devices CIV and CII are adjusted to have the same focal length and to capture digital images relating to the same objects of the observation area ZO. The capture devices CIV and CII are disposed side-by-side, for example, or one above the other.

The visible image capture device CIV, also referred to as an imaging device, is a digital still camera, a digital video camera, a camcorder or a webcam, for example.

A visible image captured in accordance with the invention is made up either of a digital image captured by a digital still camera, for example, or a plurality of digital images forming a video sequence captured by a video camera or a camcorder, for example. The visible image capture device CIV transmits a real digital image IR representing the observation area ZO to the image segmentation device DSI.

The invisible image capture device CII includes light-emitting diodes LED, an optical system and a CCD (Charge-Coupled Device) matrix, for example. The diodes are disposed in the form of a matrix or strip and emit a beam of electromagnetic waves in the invisible spectrum, such as the infrared spectrum, toward the observation area ZO. The optical system causes the beam emitted by the diodes and reflected from surfaces of objects of the observation area to converge toward the CCD matrix.

Photosensitive elements of the CCD matrix are associated with respective capacitors for storing charges induced by the absorption of the beam by the photosensitive elements. The charges contained in the capacitors are then converted, in particular by means of field-effect transistors, into voltages usable by the invisible image capture device CII which then associates a level of luminance with each photosensitive element voltage.

The luminance levels obtained depend on the energy of the beam of absorbed electromagnetic waves, and consequently on the material of the objects from which the beam is reflected. The invisible image capture device CII then transmits a monochrome digital luminance level image INL signal to the image segmentation device DSI. The luminance level image INL comprises a predetermined number of pixels according to a digital image resolution specific to the CCD matrix and, the higher the luminance level of the received signal, the brighter each pixel.

Moreover, the invisible image capture device CII is capable of evaluating the distance at which each object of the observation area ZO is located, for example as a function of the round trip time of the beam of electromagnetic waves between the time at which it was emitted and the time at which it was received by the CCD matrix. A limit time is predetermined in order to eliminate electromagnetic waves that have been reflected more than once, for example. The invisible image capture device CII then transmits a digital color level image INC to the image segmentation device DSI. Each pixel of the image INC corresponds to a point of an object of the observation area ZO according to a digital image resolution specific to the CCD matrix, and the color of a pixel belongs to a predetermined color palette and represents a distance at which the point corresponding to the pixel is located.

The invisible image capture device CII has an image refresh frequency of the order of 50 or 60 Hz, for example, corresponding to an image frame frequency in the visible image capture device CIV, in order to capture and to reconstitute in real time a succession of digital images at a known image frequency of 25 or 30 Hz at the output of the device CIV.

Alternatively, a heat-sensitive camera is used instead of or in addition to the invisible image capture device CII to obtain a digital image similar to the luminance level image INL. The heat-sensitive camera does not emit any electromagnetic beam and reacts to the temperature of the objects of the observation area, by means of a CCD matrix sensitive to the infrared waves emitted by living bodies that give off heat. The heat-sensitive camera distinguishes living bodies, such as the user, from inanimate bodies, through the difference in the heat that they give off.

The image segmentation device DSI is a data processing device that includes a distance estimation module ED, a captured image merging module FIC, a movement detector DM, and a user interface including a display screen EC and a keyboard.

The image segmentation device DSI is a personal computer, for example, or a cellular mobile radio communication terminal.

According to other examples, the image segmentation device DSI includes an electronic telecommunication object that may be a communicating personal digital assistant PDA or an intelligent telephone (SmartPhone). More generally, the image segmentation device DSI may be any other portable or non-portable communicating domestic terminal such as a video games console or an intelligent television receiver cooperating with a remote controller with a display or an alphanumeric keyboard with built-in mouse operating over an infrared link.

For example, the capture devices CIV and CII are connected by USB cables to the image segmentation device DSI, which is a personal computer.

Alternatively, the capture devices CIV and CII are included in the image segmentation device DSI, which is a cellular mobile radio communication terminal, for example.

Another alternative is for the functional means of the capture devices CIV and CII to be included in a single image capture device.

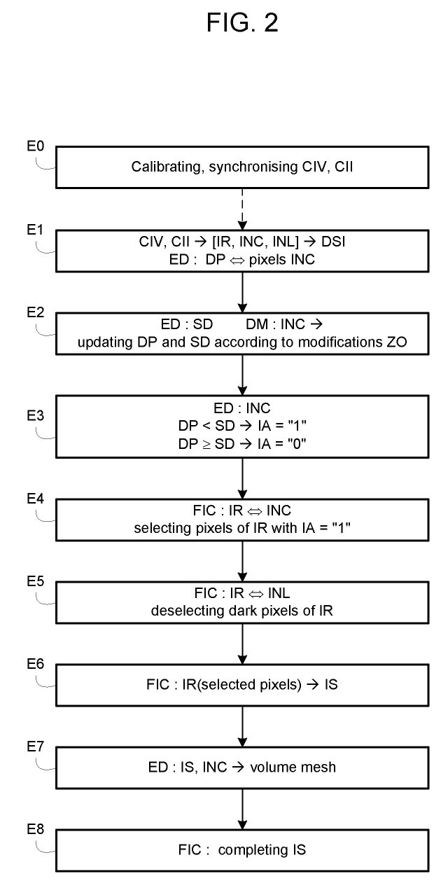

Referring to FIG. 2, the digital image segmentation method according to the invention includes steps E1 to E8 executed automatically in the image capture system.

The user UT, who is situated in the observation area of the image capture devices CIV and CII, communicates, for example interactively, with a remote party terminal during a videoconference and wishes to transmit to that remote party only a portion of the real image IR captured by the image capture device CIV. The image portion is a segmented image representing at least partially the user and the residual portion of the real image IR is eliminated or replaced by a digital image, for example, such as a fixed or animated background, prestored in the device DSI and selected by the user.

The steps of the method are executed for each set of three digital images IR, INC and INL captured simultaneously by the image capture devices CIV and CII, and consequently at a refresh frequency of the devices CIV and CII, in order to transmit a video sequence from the user to the other party in real time.

In an initial step E0, the image capture devices CIV and CII are calibrated and synchronized: the focal lengths of the two devices are adjusted, mechanically and/or electrically, and timebases in the devices are synchronous with each other in order to capture and recovery at the same times digital images relating to the same objects of the observation area ZO, and references for displaying the captured digital images coincide. Consequently, if at a given time the image captured by the visible image capture device CIV is superposed on the image captured by the invisible image capture device CII, the centres of the captured images coincide and the dimensions of the images of the same object are respectively proportional in the two images.

In the step E1, the images captured by the image capture devices CIV and CII, i.e. the real image IR, the color level image INC and/or the luminance level image INL, are transmitted to the image segmentation device DSI, which recoveries and displays the captured images on the display screen EC.

For example, as shown diagrammatically in FIG. 1, in three juxtaposed windows of the screen EC there are displayed the real image IR captured by the visible image capture device CIV and the color level image INC and the luminance level image INL captured by the invisible image capture device CII.

The color level image INC is displayed with a predefined resolution, for example 160×124 pixels, each pixel of the image INC having a color in a color palette, such as a palette of the spectrum of light, or selected from a few colors such as red, green and blue. For example, a pixel having a dark blue color displays a point of an object close to the capture device CII and a pixel having a yellow or red color displays a point of an object far from the capture device CII. The distance estimation module ED interprets the colors of the pixels of the image INC and associates respective distances DP with the pixels of the image INC.

The luminance level image INL is also displayed with a predefined resolution, for example 160×124 pixels, each pixel of the image INL having a grey luminance level between a white level corresponding to a maximum luminance voltage and a black level corresponding to a minimum luminance voltage. The pixels of the monochrome luminance level image INL are brighter when they are displaying an object OBP of the observation area that is close to the device CII and the surface whereof reflects well the beam of electromagnetic waves emitted by the device CII. In contrast, the pixels of the image INL are darker when they are displaying an object OBE of the observation area that is far from the device CII and the surface whereof reflects less well the beam of electromagnetic waves emitted by the device CII. Indeed the luminance level in the signal transmitted by the CCD matrix of the invisible image capture device CII depends on the material of the objects from which the beam emitted by the device CII is reflected. Each pixel of the image INL is therefore associated with a luminance level.

In the step E2, the distance estimation module ED proceeds to a thresholding operation by determining a distance threshold SD relating to a background dome in the color level image INC relative to the invisible image capture device CII and a relatively low luminance threshold in the image INL corresponding for example to points of the area ZO far from the capture system.

The distance threshold SD is predetermined and fixed, for example. The distance threshold SD may be equal to a distance of about one meter in order to cover most possible positions of the user in front of the invisible image capture device CII.

In another example, the movement detected DM detects changes of position and in particular movements of objects or points of the observation area ZO and even more particularly any modification of distances associated with the pixels of the color level image INC. It is often the case that the objects in the observation area are fixed and the user is constantly moving; only movements of the user UT are detected and the estimation module ED updates the distances DP associated with the pixels relating to a portion of the color level image INC representing the user by successive comparisons of consecutive captured images two by two. The distance estimation module ED then adapts the distance threshold SD to the distances updated by the movement detector DM and the distance threshold is at least equal to the greatest updated distance. This adaptation of the distance threshold SD avoids pixels corresponding to portions of the user such as an arm or a hand from being associated with distance exceeding the distance threshold and consequently not being displayed.

Moreover, the distance estimation module ED fixes a limit on the value that the distance threshold SD may assume. For example, the distance threshold may not exceed a distance of two to three meters from the image capture device CII, in order to ignore movements that do not relate to the user, such as a person entering the observation area ZO in which the user is located.

In the step E3, the estimation module ED assigns a Boolean display indicator IA to each pixel of the image INC. In particular, a display indicator IA with the logic state “0” is assigned to each pixel associated with a distance DP greater than or equal to the distance threshold SD and a display indicator IA with the logic state “1” is assigned to each pixel associated with a distance DP less than the distance threshold SD.

When at least two color level images INC have been captured and transmitted to the image segmentation device DSI, the distance estimation module ED modifies the states of the display indicators IA assigned to the pixels the distances whereof have been updated.

In the example with a red-green-blue color palette, if the distance threshold DS is one meter and the user is situated at less than one meter from the invisible image capture device CII without there being any object near the user UT, the shape of the user is displayed in dark blue and a display indicator IA with the logic state “1” is assigned to all the pixels relating to the user, while a display indicator IA with the logic state “0” is assigned to all the other pixels relating to the observation area displayed with colors from pale blue to red.

In the step E4, the captured image merging module FIC establishes a correspondence between the pixels of the color level image INC and the pixels of the real image IR. Because the centres of he captured images INC and IR coincide and the dimensions of the objects in the images INC and IR are proportional, a pixel of the color level image INC corresponds to an integer number of pixels of the real image IR, according to the resolutions of the images INC and IR.

The captured image merging module FIC selects the pixels of the real image IR corresponding to the pixels of the color level image INC assigned a display indicator IA with the logic state “1”, i.e. the pixels associated with distances DP less than the distance threshold SD. Also, the module FIC does not select other pixels of the real image IR corresponding to the pixels of the color level image INC assigned a display indicator IA with the logic state “0”, i.e. the pixels associated with distances DP greater than or equal to the distance threshold SD.

The selected pixels of the real image IR then relate to the user UT and possibly to objects situated near the user.

In the optional step E5, the captured image merging module FIC also establishes a correspondence between the pixels of the real image IR and the pixels of the luminance level image INL. As for the color level image INC, a pixel of the luminance level image INL corresponds to an integer number of pixels of the real image IR, according to the resolutions of the images INL and IR. Because a luminance level is associated with each pixel of the image INL and the luminance level depends on the material of the objects from which the beam of electromagnetic waves is reflected, it is generally the case that only the pixels displaying portions of the user UT are bright and the pixels displaying the residual portion of the observation area are very dark or black.

The captured image merging module FIC effects a correlation between the pixels of the real image IR selected from the color level image INC and the pixels of the real image IR selected from the luminance level image INL, in order to distinguish groups of selected pixels of the real image IR that represent the user relative to groups of pixels of the real image IR that represent one or more objects. The captured image merging module FIC then deselects the groups of pixels of the real image IR associated with a luminance level less than the predetermined luminance threshold, such as the dark or black pixels displaying an object or objects. Consequently, only the pixels of the real image IR relating to the user UT are selected and any object situated near the user is ignored.

The step E5 may be executed before or at the same time as the step E4. Following the steps E4 and E5, the captured image merging module FIC displays in the step E6 on the screen EC only the selected pixels of the real image IR to form a segmented image IS, the residual portion of the real image being displayed in the form of a monochrome background, for example, in black, for instance. The real image IR is then divided into the segmented image IS that shows on the screen EC only portions of the observation area ZO relating to the user.

If the step E5 is not executed, the segmented image IS shows on the screen EC portions of the observation area relating to the user and possibly objects situated near the user.

It is necessary to use both the images INC and INL to specify the contour of the image of the user in a segmented image. In fact, the color level image INC distinguishes the portions of the user UT and objects near the user from the remainder of the observation area, but in an imprecise manner since portions of the user such as individual hairs are not displayed distinctly, whereas the luminance level image INL distinguishes all portions of the user UT precisely, including individual hairs, from any object of the observation area. In this particular case of distinguishing individual hairs, the captured image merging module FIC can select pixels in the real image IR that were not selected by the merging module FIC in the step E4 and are assigned a display indicator IA with the logic state “0”. The selected pixels then relate to the user and are associated with a luminance level higher than the predetermined luminance threshold.

In the optional step E7, the distance estimation module ED constructs a volume mesh as a function of the color level image INC or the segmented image IS. A pixel of the color level image INC is associated with a distance DP and corresponds to a number of pixels of the real image IR and therefore of the segmented image IS. Consequently, said number of pixels of the segmented image IS is also associated with the distance DP. All the displayed pixels of the segmented image IS, or more generally all the pixels of the real image IR assigned a display indicator IA with the logic value “l”, are associated with respective distances DP and implicitly with coordinates in the frame of reference of the segmented image IS. The distance estimation module ED exports the segmented image IS, more particularly the distances and coordinates of the displayed pixels, in a digital file to create a virtual object with three dimensions. Indeed all the pixels relating to the user have three coordinates and define a tridimensional representation of the user.

Constructing the volume mesh therefore creates tridimensional objects that can be manipulated and used for different applications, such as video games or virtual animations.

In the step E8, the captured image merging module FIC modifies the segmented image IS by inserting in the background of the segmented image IS a fixed or animated background image selected beforehand by the user UT, in order for the user to appear in a virtual decor, for example, or in the foreground of a photo appropriate to a particular subject.

The image segmentation device DSI then transmits the modified segmented image to a terminal of the party with whom the user is communicating in a videoconference.

The steps E1 to E8 being repeated automatically for each of the images captured by the devices CIV and CII, for example at an image frequency of the order of 50 or 60 Hz, the other party views in real time a video sequence comprising the segmented images modified as required by the user.

The invention described here relates to a segmentation method and device for segmenting a first digital image of an observation area ZO, such as the real image IR, captured by a first capture device, such as the visible image capture device CIV, and transmitted to the segmentation device. In a preferred embodiment, the steps of the method of the invention are determined by the instructions of a computer program incorporated in a data processing device such as the image segmentation device DSI according to the invention. The program includes program instructions which, when said program is executed in a processor of the data processing device the operation whereof is then controlled by the execution of the program, execute the steps of the method according to the invention.

As a consequence, the invention applies also to a computer program, in particular a computer program on or in an information medium readable by a data processing device, adapted to implement the invention. That program may use any programming language and be in the form of source code, object code or an intermediate code between source code and object code, such as a partially compiled form, or in any other desirable form for implementing the method according to the invention.

The information medium may be any entity or device capable of storing the program. For example, the medium may include storage means or a recording medium on which the computer program according to the invention is recorded, such as a ROM, for example a CD ROM or a microelectronic circuit ROM, or a USB key, or magnetic recording means, for example a diskette (floppy disk) or a hard disk.

Moreover, the information medium may be a transmissible medium such as an electrical or optical signal, which may be routed via an electrical or optical cable, by radio or by other means. The program according to the invention may in particular be downloaded over an internet type network.

Alternatively, the information medium may be an integrated circuit in which the program is incorporated, the circuit being adapted to execute or to be used in the execution of the method according to the invention.

What we claim is:

1. A method for segmenting in real time a first digital image of an observation area captured by an image capture system that also captures a second digital image of said observation area, said method including the following steps executed in said image capture system:
establishing a correspondence between pixels of said first digital image and pixels of said second digital image,
selecting pixels of said first digital image corresponding to pixels of said second digital image into selected pixels as a function of magnitudes associated with said pixels of said second digital image, and
displaying only said selected pixels of said first digital image to form a segmented image.

2. A method according to claim 1, including updating of said magnitudes associated with the pixels of said second digital image relating to observation area points whose position has changed.

3. A method according to claim 1, wherein the magnitude associated with a pixel of said second digital image is a distance between a point of said observation area and said image capture system.

4. A method according to claim 3, including further determining a distance threshold in said second digital image relative to said image capture system, said pixels of said second digital image corresponding to said selected pixels of said first digital image being associated with distances less than said distance threshold.

5. A method according to claim 4, wherein including updating of said distances associated with the pixels of said second digital image relating to observation area points whose position has changed, said distance threshold being at least equal to the greatest updated distance.

6. A method according to claim 1, including further establishing a correspondence between pixels of said first digital image and pixels of a third digital image representing luminance levels of the observation area, and deselecting the pixels of said first digital image that are associated with a luminance level less than a predetermined threshold.

7. A method according to claim 1, including constructing a volume mesh as a function of said segmented image by associating distances and coordinates of a frame of reference of said segmented image respectively with the pixels of said segmented image in order to create a tridimensional virtual object.

8. A method according to claim 1, including further modifying said segmented image by inserting a background image into the background of said segmented image.

9. A method according to claim 1, wherein a user of said image capture system in said area observation communicates interactively with a remote terminal to which said segmented image representing at least partially said user is transmitted.

10. An image capture system for real time segmentation of a first digital image of an observation area, including a device for capturing said first digital image and a device for capturing a second digital image of said observation area, said image capture system including:
an establishing arrangement for establishing a correspondence between pixels of said first digital image and pixels of said second digital image,
a selecting arrangement for selecting pixels of said first digital image corresponding to pixels of said second digital image into selected pixels as a function of magnitudes associated with said pixels of said second digital image, and
a displaying arrangement for displaying only said selected pixels of said first digital image to form a segmented image.

11. A terminal adapted to real time segment a first digital image of an observation area, including:
a capturing arrangement for capturing said first digital image,
a capturing arrangement for capturing a second digital image of said observation area,
an establishing arrangement for establishing a correspondence between pixels of said first digital image and pixels of said second digital image,
a selecting arrangement for selecting pixels of said first digital image corresponding to pixels of said second digital image into selected pixels as a function of magnitudes associated with said pixels of said second digital image, and
a displaying arrangement for displaying only said selected pixels of said first digital image to form a segmented image.

12. A segmentation device for real time segmentation of a first digital image of an observation area captured by a capture device and transmitted to said segmentation device, a second digital image of the observation area being captured and transmitted by another capture device to said segmentation device, said segmentation device including:
an establishing arrangement for establishing a correspondence between pixels of said first digital image and pixels of said second digital image,
a selecting arrangement for selecting pixels of said first digital image corresponding to pixels of said second digital image into selected pixels as a function of magnitudes associated with said pixels of said second digital image, and
a displaying arrangement for displaying only said selected pixels of said first digital image to form a segmented image.

13. A computer program adapted to be executed in a segmentation device for real time segmentation of a first digital image of an observation area captured by a capture device and transmitted to the segmentation device, a second digital image of said observation area being captured and transmitted by another capture device to said segmentation device, said program including instructions which, when said program is executed in said segmentation device, execute the steps of:
establishing a correspondence between pixels of said first digital image and pixels of said second digital image and selecting pixels of said first digital image corresponding to pixels of said second digital image into selected pixels as a function of magnitudes associated with said pixels of said second digital image, and
displaying only said selected pixels of said first digital image to form a segmented image.

14. An information medium readable by a segmentation device on which a computer program is stored for real time segmentation of a first digital image of an observation area captured by a capture device and transmitted to the segmentation device, a second digital image of said observation area being captured and transmitted by another capture device to said segmentation device, said program including instructions for executing the steps of:
establishing a correspondence between pixels of said first digital image and pixels of said second digital image and selecting pixels of said first digital image corresponding to pixels of said second digital image into selected pixels as a function of magnitudes associated with said pixels of said second digital image, and
displaying only said selected pixels of said first digital image to form a segmented image.
